(19) United States
(12) Patent Application Publication
(10) Pub. No.: US 2018/0007760 A1
(43) Pub. Date: Jan. 4, 2018

(54) COMPENSATION FOR LED TEMPERATURE DRIFT

(71) Applicant: Intel Corporation, Santa Clara, CA (US)

(72) Inventor: Mikko Ollila, Tampere (FI)

(73) Assignee: Intel Corporation, Santa Clara, CA (US)

(21) Appl. No.: 15/196,477

(22) Filed: Jun. 29, 2016

(51) Int. Cl. H05B 33/08; G02F 1/137; G02B 5/20; G02B 13/08; H04N 5/33; H04N 5/225

(52) U.S. Cl. CPC H05B 33/0872; H04N 5/33; H04N 5/2256; G02B 5/208; G02B 13/08; G02F 1/137

(57) ABSTRACT

An electronic device for compensating for temperature drift of a light emitting diode (LED) is described. The electronic device comprises an LED assembly to illuminate a facial feature. The LED assembly comprises an LED and a temperature sensor to measure a temperature of the LED. The electronic device also comprises a tunable filter to filter a wavelength of a pass band of light as the temperature of the LED changes as indicated by the temperature sensor and an image sensor to receive the pass band of light filtered by the tunable filter.

### TECHNICAL FIELD

The present disclosure relates generally to techniques for compensating for temperature drift in infrared light emitting diodes. More specifically, the present techniques relate to compensating for temperature drift in infrared light emitting diodes using tunable filters.

### BACKGROUND ART

Biometric systems are used for identification and access control. Facial recognition and iris recognition are types of biometric systems. Images of the face and iris are obtained using light in the infrared region of the electromagnetic spectrum. Infrared light is used because it provides better images than visible light. Features of the face or iris appear more textured in infrared light than in visible light.

### BRIEF DESCRIPTION OF THE DRAWINGS

FIG. 1 is a block diagram of an electronic device that uses a tunable filter to compensate for the temperature drift of an infrared light emitting diode.

FIG. 2 is an illustration of an image sensor assembly that includes a tunable filter.

FIG. 3 is an illustration of an image sensor assembly that includes an example of a tunable filter.

FIG. 4 is an illustration of an image sensor assembly that includes another example of a tunable filter.

FIG. 5A is an illustration of an embodiment of an infrared pass filter.

FIG. 5B is an illustration showing compensation for the temperature drift of an infrared LED.

FIG. 6 shows a function of the infrared pass filter.

FIG. 7 is a process flow diagram of a method for compensating for thermal drift in an infrared light emitting diode.

FIG. 8 is a block diagram showing a medium that contains logic for compensating for thermal drift in an infrared light emitting diode.

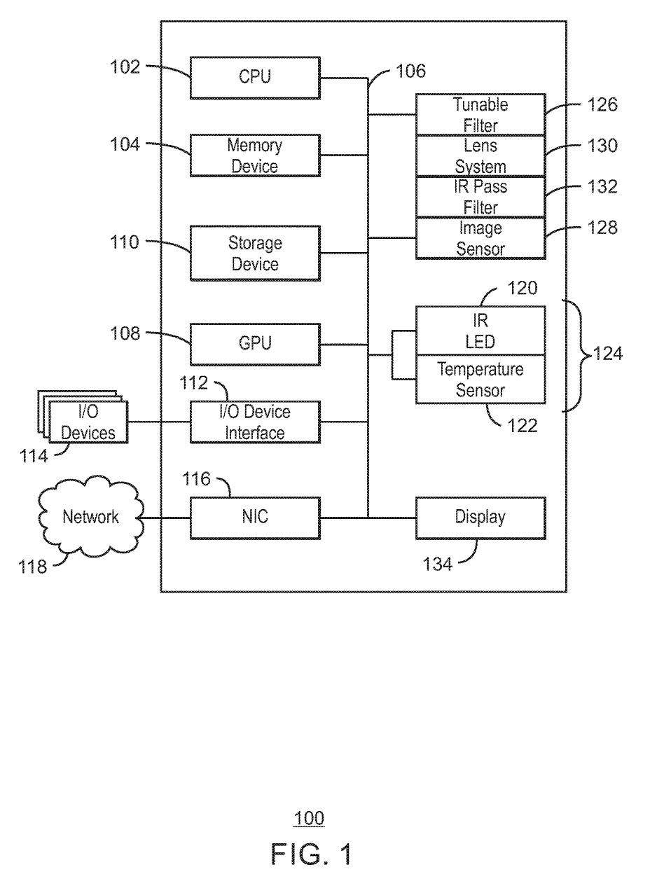

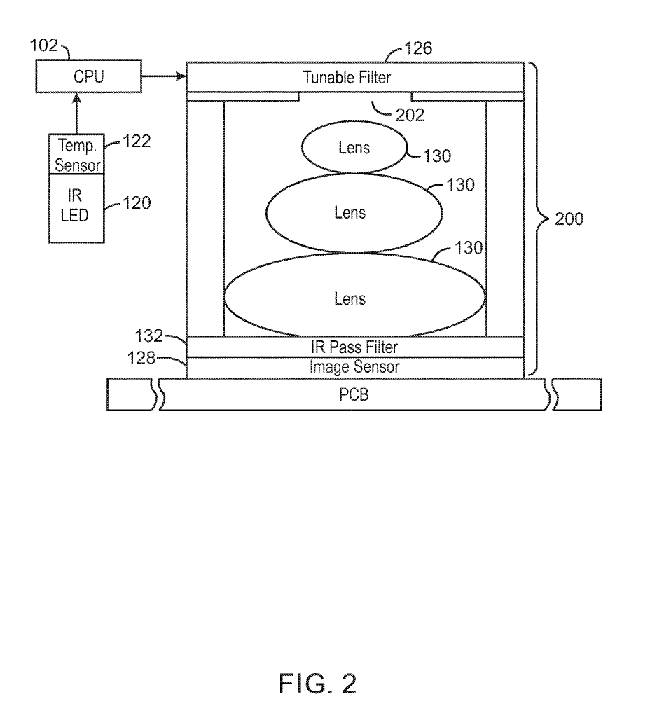

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Biometric systems that image the face or iris have IR light sources that are driven at high current. This is because the efficiency of a light emitting diode (LED) is poor in the infrared (IR) region of the electromagnetic spectrum. In addition, an IR LED has to be operated at high current to compensate for ambient IR light from the sun. Operation at high current produces heat. The IR LED is small and often located at the top of a device making heat dissipation difficult. Thus, the IR LED will heat up quickly causing the center frequency of the LED to drift by 2 nm/degree.

For reliability and anti-spoofing reasons, the IR spectrum received by an image sensor should be as narrow as possible. Too wide a spectrum affects the ability of the image sensor to provide a consistent image in diverse lighting. Furthermore, if the spectrum is too wide, subtle changes in appearance, such as facial hair, make up, or eye wear, will deceive a biometric identification system.

The subject matter disclosed herein relates to techniques for compensating for temperature drift in an IR LED. The present disclosure describes techniques for compensating for temperature drift in an IR LED using tunable filters. For example, a facial feature may be illuminated by an IR LED assembly. The IR LED assembly may be made up of an IR LED and a temperature sensor to measure the temperature of the IR LED. A tunable filter may be used to filter the light to allow a narrow pass band of light to enter an image sensor. As the temperature of the IR LED drifts as indicated by the temperature sensor, the passband may be tuned to follow the wavelength of the light emitted by the IR LED. Various examples of the present techniques are described further below with reference to the figures.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

FIG. 1 is a block diagram of an electronic device that uses a tunable filter to compensate for the temperature drift of an IR LED. For example, the electronic device 100 may be a laptop computer, tablet computer, mobile phone, smart phone, or any other suitable electronic device. The electronic device 100 may include a central processing unit (CPU) 102 that is configured to execute stored instructions, as well as a memory device 104 that stores instructions that are executable by the CPU 102. The CPU 102 may be coupled to the memory device 104 by a bus 106. The CPU 102 may be a single core processor, a multi-core processor, a computing cluster, or any number of other configurations. The CPU 102 may be implemented as a Complex Instruction Set Computer (CISC) processor, a Reduced Instruction Set Computer (RISC) processor, x86 Instruction set compatible processor, or any other microprocessor or central processing unit. In some embodiments, the CPU 102 includes dual-core processor(s), dual-core mobile processor(s), or the like.

The memory device 104 may include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory system. The memory device 104 can be used to store data and computer-readable instructions that, when executed by the CPU 102, direct the CPU 102 to perform various operations in accordance with embodiments described herein.

The electronic device 100 may also include a graphics processing unit (GPU) 108. As shown, the CPU 102 may be coupled to the GPU 108 via the bus 106. The GPU 108 may be configured to perform any number of graphics operations. For example, the GPU 108 may be configured to render or manipulate images of a face or an iris.

The electronic device 100 may also include a storage device 110. The storage device 110 is a physical memory device such as a hard drive, an optical drive, a flash drive, an array of drives, or any combinations thereof. The storage device 110 may store data such as face or iris images, among other types of data. The storage device 110 may also store programming code such as device drivers, software applications, operating systems, and the like. The programming code stored by the storage device 110 may be executed by the CPU 102, GPU 108, or any other processors that may be included in the electronic device 100.

The electronic device 100 may also include an input/output (I/O) device interface 112 configured to connect the electronic device 100 to one or more I/O devices 114. For example, the I/O devices 114 may include a printer, a scanner, a keyboard, and a pointing device such as a mouse, touchpad, or touchscreen, among others. The I/O devices 114 may be built-in components of the electronic device 100, or may be devices that are externally connected to the electronic device 100.

The electronic device 100 may also include a network interface controller (NIC) 116 configured to connect the electronic device 100 to a network 118. The network 118 may be a wide area network (WAN), local area network (LAN), or the Internet, among others.

The IR LED 120 and the temperature sensor 122 may be part of an IR LED assembly 124. The temperature sensor 122 may monitor the temperature of the IR LED 120 as the temperature of the IR LED 120 drifts. The tunable filter 126 may compensate for the drift by adjusting the pass band of light that reaches the image sensor 128. The image sensor 128 may capture images using the adjusted band of light. For example, the image sensor 128 may be used to obtain face or iris images.

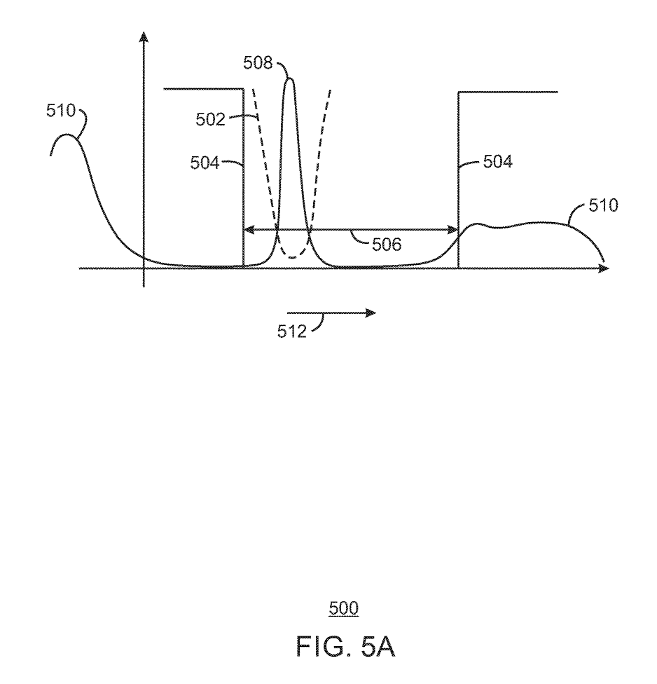

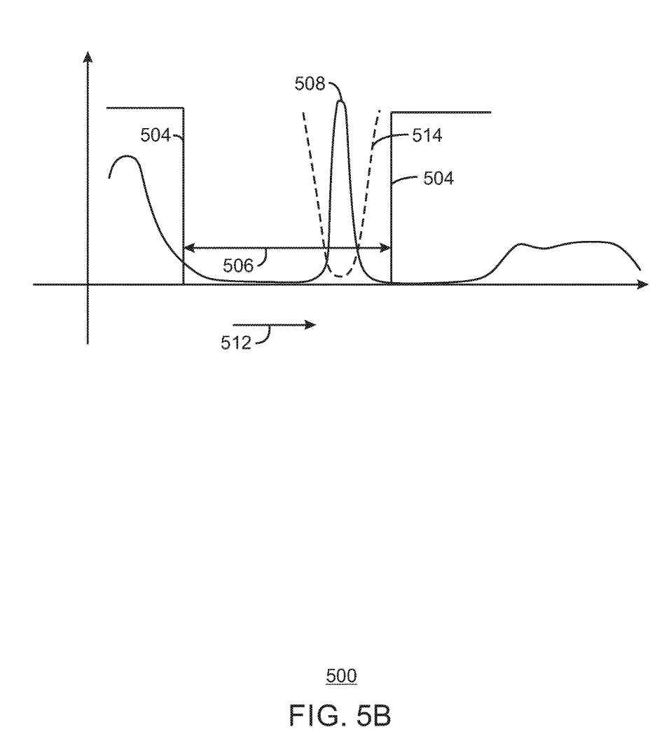

A lens system 130 and an IR pass filter 132 may be disposed between the image sensor 128 and the tunable filter 126. The lens system 130 may serve to focus the pass band of light on the IR pass filter 132. In turn, the IR pass filter 132 may sharpen the pass band of light by correcting for the non-ideal transmission profile of the tunable filter 126. The IR pass filter 132 may have sharp edges and may eliminate any light transmitted through the tunable filter that is beyond the filter edges, as explained further with respect to FIG. 5A.

The electronic device 100 may further include a display 134. The display 134 may present images and video captured by the image sensor 128.

Communication between various components of the electronic device 100 may be accomplished via one or more busses 106. In some examples, the bus 106 may be a single bus that couples all of the components of the electronic device 100 according to a particular communication protocol. Furthermore, the electronic device 100 may also include any suitable number of busses 106 of varying types, which may use different communication protocols to couple specific components of the electronic device 100 according to the design considerations of a particular implementation.

The block diagram of FIG. 1 is not intended to indicate that the electronic device 100 is to include all of the components shown in FIG. 1. Rather, the electronic device 100 can include fewer or additional components not shown in FIG. 1, depending on the details of the specific implementation. Furthermore, any of the functionalities of the CPU 102 or the GPU 108 may be partially, or entirely, implemented in hardware and/or a processor. For example, the functionality may be implemented in any combination of Application Specific Integrated Circuits (ASICs), Field Programmable Gate Arrays (FPGAs), logic circuits, and the like. In addition, embodiments of the present techniques can be implemented in any suitable electronic device, including ultra-compact form factor devices, such as System-On-a-Chip (SOC), and multi-chip modules.

FIG. 2 is an illustration of an image sensor assembly 200 that includes a tunable filter 126. As shown in FIG. 2, the image sensor assembly 200 may include an image sensor 128, an IR pass filter 132, a lens system 130, and an aperture 202. In a device lacking a tunable filter 126, the pass band of light received from a face or an iris may enter the image sensor assembly via the aperture 202. A lens system 130 composed of one or more lenses focuses the received pass band on the image sensor 128. An IR pass filter 132 may be located between the lens system 130 and the image sensor 128. The IR pass filter 132 filters incoming light by allowing a pass band of a fixed wavelength of light to pass through the IR pass filter 132. The pass band of the IR pass filter 132 is wide enough to accommodate the range of possible frequencies that may be emitted by the IR LED 120 as a result of temperature drift. The IR pass filter 132 may also act as a dust shield to protect the image sensor 128 from dust.

The image sensor assembly 200 may include a tunable filter 126. The tunable filter 126 can be made transmissive for certain wavelengths of light. The tunable filter 126 may allow only a received pass band that is very narrow to enter the aperture 202. There may be an additional aperture (not shown) on top of the tunable filter 126 to prevent light from passing through non-active but transparent structures of the tunable filter 126.

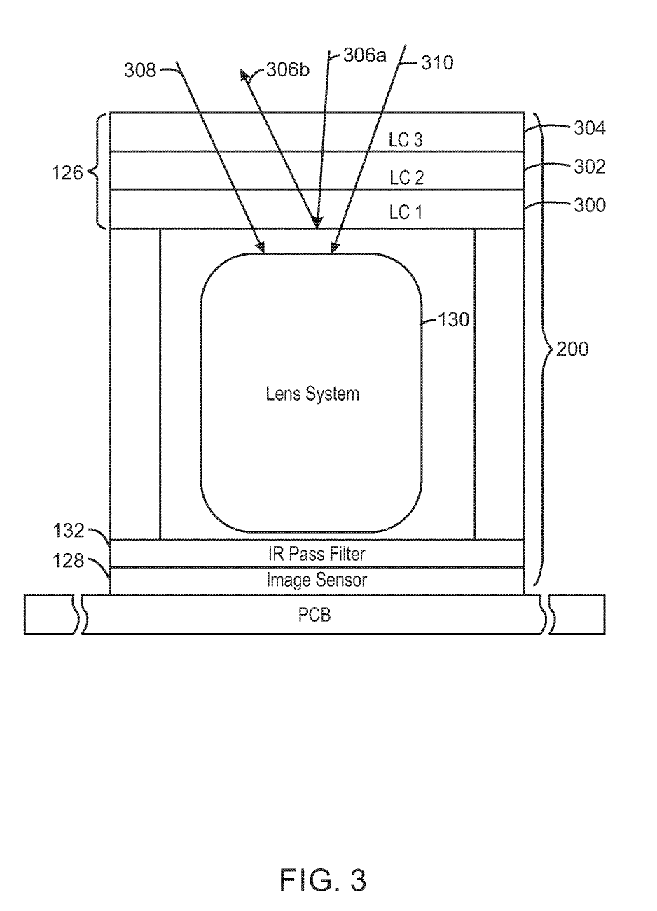

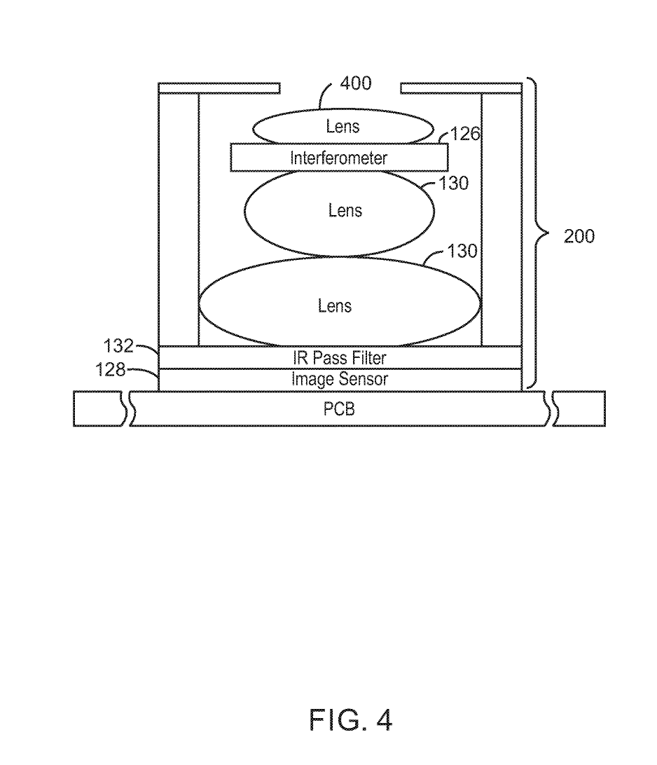

Adjustment of the tunable filter 126 may compensate for the temperature drift of the IR LED 120. The tunable filter 126 may be adjusted by the CPU 102. The CPU 102 receives input from the temperature sensor 122 as to the temperature of the IR LED 120 and adjusts the pass band of light transmitted by the tunable filter 126 as the temperature of the IR LED 120 drifts. The tunable filter 126 may be at least one of an electrochromic filter, a liquid crystal filter, or an interferometer. The liquid crystal filter and the interferometer are described with respect to FIGS. 3 and 4, respectively.

Because of the tunable filter 126, it is not necessary to set a wide pass band to accommodate the temperature drift of the IR LED 120. The width of the pass band may be as narrow as 5 to 20 nm. By making the received pass band as narrow as possible, spoofing becomes less likely and security may be enhanced. IR LEDs 120 can be used in devices where only poor thermal conduction exists because of limited space. The cost of IR devices is reduced. For example, an IR LED 120 can be placed on flexible circuit board instead of more costly printed circuit board. In addition, cheaper IR LEDs 120 may be used because the LED packaging can be of the low thermal conduction type. In addition, much higher current LEDs may be used, which increases the working distance of the IR device. As a result, the IR device can be used in higher ambient IR light conditions.

An example of a tunable filter that may be used to compensate for IR LED temperature drift is an electrochromic filter. Bursts of charge may be used to cause electrochemical redox reactions and resultant color changes in electrochromic materials. Depending on the color change, certain wavelengths of IR light may be absorbed and certain wavelengths may be transmitted. The color change that occurs may be the result of the type of electrochromic material and the magnitude of the applied charge. By varying the magnitude of the applied charge, an electrochromic filter may compensate for the change in the wavelength of the light produced by an IR LED that results when the temperature of the IR LED increases.

FIG. 3 is an illustration of an image sensor assembly 200 that includes another example of a tunable filter 126. In this example, the tunable filter 126 is a liquid crystal (LC) filter. The tunable filter 126 shown in FIG. 3 includes three LC film layers, LC1 300, LC2 302, and LC3 304. LC1 300, LC2 302, and LC3 304 may filter the band of light received from a face or an iris so that a very narrow pass band of IR light reaches the image sensor 128. The LC film 126 may compensate for the drift of the wavelength of light produced by the IR LED as the temperature of the IR LED increases. Although the LC film 126 shown in FIG. 3 includes three LC layers, any number of layers may be used depending on the specifics of the implementation.

A thin LC layer (approximately 5 μm thick) can be made reflective for certain wavelengths and transmissive for other wavelengths depending on an excitation frequency and a voltage applied to the LC layer. The LC material, the crystal alignment, and the thickness of the layer also affect the bandwidths that are reflected and transmitted. In embodiments of the present techniques, a single LC layer may be used to filter IR light by changing the excitation frequency and the voltage applied to the layer. In other embodiments, such as that shown in FIG. 3, a number of LC layers 300, 302, 304 may be used. Each layer is responsive to a certain band of IR light so that certain wavelengths are reflected 306a, 306b and other wavelengths are transmitted 308, 310. The different layers 300, 302, 304 are activated or deactivated to tune the IR light returning from a face or an iris. The transmitted wavelengths 308, 310 are focused on the IR pass filter 132 by the lens system 130. The IR pass filter 132 removes any transmitted light outside the filter edges. After passing through the IR pass filter 132, the transmitted wavelengths 308, 310 reach the image sensor 128. In this manner, an image of the face or iris is obtained. The wavelength of the transmitted IR light is determined by the reflective properties of the LC layer(s). Hence, the LC layer(s) may be referred to as an LC reflector.

LC layers have a polarizing effect. As a result, the reflectance of the IR light is only in one direction of polarization and only half of the returning light is reflected. In some embodiments, another LC layer with a perpendicular polarization may be added to provide 100% reflectivity. In other embodiments, each LC layer may have two components, one for each polarization direction. For example, within one layer, there may be a component for vertical polarization and a component for horizontal polarization. With 100% reflectivity of certain wavelengths, other wavelengths are transmitted by the LC layer and reach the image sensor 128.

In addition to the LC film 126 described above, there may be other assemblies that can be used to tune IR light returning from a face or an iris. For example, other assemblies may include an interferometer to correct the returned band of light as the wavelength of light produced by the IR LED drifts as the temperature of the IR LED increases.

FIG. 4 is an illustration of an image sensor assembly 200 that includes yet another example of a tunable filter 126. In this example, the tunable filter 126 is an interferometer. An example of such an interferometer is the Fabry-Perot interferometer (FPI). The interferometer 126 includes two reflective mirror surfaces with a gap between them. Examples of the reflective mirror surfaces include thin film Bragg reflectors. The wavelength of light returned from a face or an iris is tuned by varying the distance between the mirrors. As the wavelength of light produced by the IR LED changes with temperature, the interferometer 126 compensates for the drift by increasing the distance between the mirrors. Pass bands as narrow as 10-15 nm have been achieved using interferometers.

The interferometer 126 may not accept light that has an incident angle greater than approximately 5 degrees. Given the narrow angle of incidence, the light transmitted by the interferometer 126 also has a narrow angle. The narrow angle of transmission may be suitable for iris imaging because only the iris has to fit inside the beam of transmitted light. However, the angle of the transmitted light may have to be widened when imaging a face. As a result, in some embodiments, an additional lens 400 may be placed on top of the interferometer 126. The additional lens 400 ensures that the maximum incident angle of approximately 5 degrees is maintained, but widens the angle of the pass band of light transmitted by the interferometer 126.

FIG. 5A is an illustration of an embodiment of an IR pass filter 500. The incoming band of IR light is filtered by an electrochromic filter, an LC filter, or an interferometer. Curve 502 represents the characteristics of the tunable filter. The IR pass filter 500 may be used to sharpen the band of IR light that has passed through the tunable filter. An IR pass filter 500 may be especially useful when the tunable filter has a non-ideal transmission profile.

The IR pass filter 500 may have sharp filter edges 504. The tunable range of the tunable filter may approximate the IR pass filter pass band 506. In the embodiment shown in FIG. 5A, the pass band 508 of the tunable filter is near the middle of the tunable range 506. The pass band 508 of the tunable filter may have relatively sharp characteristics. However, the tunable filter may have a non-ideal transmission profile in that there may be some transmission 510 through the tunable filter that is outside the tunable range 506 or desired band. The IR pass filter 500 may prevent these transmissions 510 from reaching the image sensor. Consequently, the signal-to-noise ratio of the pass band 508 of the tunable filter may not decrease.

FIG. 5B is an illustration showing compensation for the temperature drift of an IR LED. As the temperature of the IR LED increases, the spectrum of IR light emitted by the IR LED moves in the direction indicated by arrow 512. The tunable filter is adjusted to compensate for the temperature drift of the IR LED as indicated by curve 514. The pass band of the tunable filter as a result of the increase in IR LED temperature is represented by curve 508. As illustrated in FIG. 5B, the adjustable pass band of the tunable filter is controlled to follow the thermal drift of the IR LED.

The IR pass filter 500 has another function in that it may protect the image sensor from dust, i.e., the IR pass filter 500 may function as a dust shield. The IR pass filter 500 may not be needed if the transmission characteristics of the tunable filter are close to ideal. The IR pass filter may be replaced with ordinary glass that functions as the dust seal.

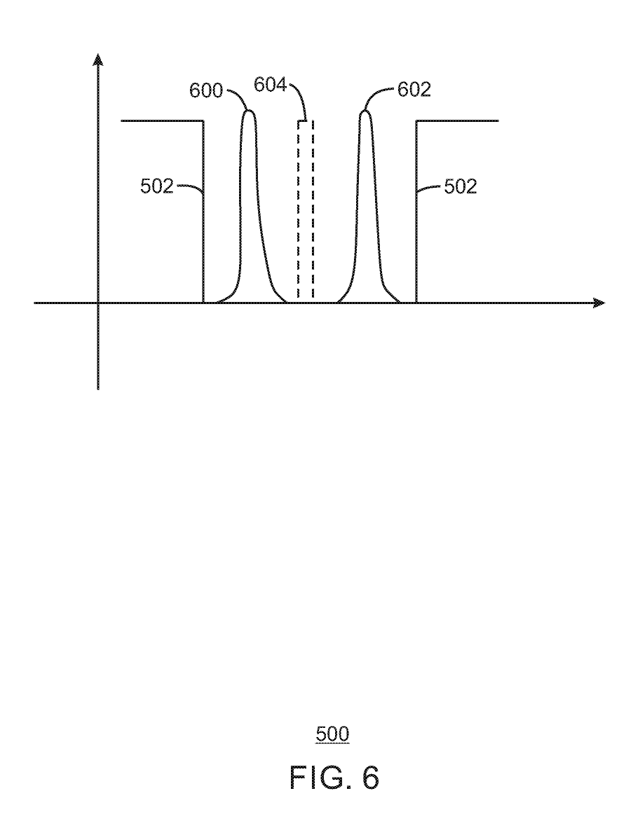

FIG. 6 shows another function of the IR pass filter 500. The IR pass filter 500 may implement stop bands between different systems for imaging a face or an iris. Different imaging systems may be used in conjunction with one another. However, the center frequency and the width of the spectral band emitted by the IR LED may differ from one imaging system to another. This may be caused by variations in manufacturing techniques and variations in the IR LED caused by thermal drift. Two spectral bands 600, 602 resulting from two different imaging systems are shown in FIG. 6. If the center frequencies are far enough apart and the width of the emitted spectral bands are narrow enough, the IR pass filter 500 may implement stop bands between the different systems to define sharp endpoints for each system. In FIG. 6, the IR pass filter 500 has implemented a stop band 604 between the spectral band 600 from one imaging system and the spectral band 602 from another imaging system. If stop bands 604 are used, the IR pass filter 500 may become a multi-band pass filter.

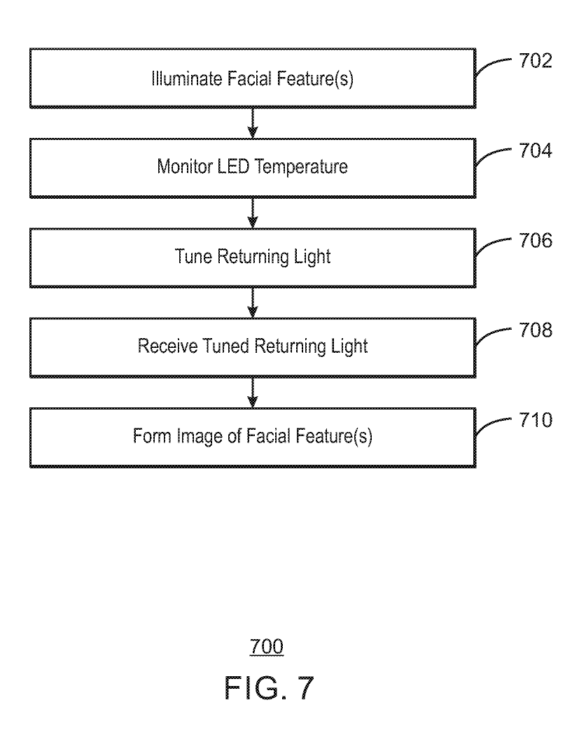

FIG. 7 is a process flow diagram of a method 700 for compensating for thermal drift in an IR LED. The method 700 may be performed by the electronic device 100 shown in FIG. 1 using the image sensor assembly 200 shown in FIG. 2.

At block 702, the face or the iris of a user may be illuminated by the IR LED 120. At block 704, the temperature drift of the IR LED 120 may be monitored by the temperature sensor 122. At block 706, the IR light returning to the electronic device 100 may be filtered by the tunable filter 126 to compensate for the temperature drift of the IR LED 120. For example, if the tunable filter is an electrochromic filter, the wavelength of the returning IR light may be tuned by changing the magnitude of the charge applied to the electrochromic material. If the tunable filter is a single LC filter, the wavelength of the returning IR light may be tuned by changing the excitation frequency and the voltage applied to the layer. In other embodiments that use multiple LC layers, the different layers are activated or deactivated to tune the IR light returning to the electronic device 100. If the tunable filter is an interferometer, the wavelength of the returning IR light may be tuned by changing the distance between the mirrors composing the interferometer. Whatever the type of filter, the tunable filter 126 adjusts the pass band of IR light to follow the drift of the IR LED 120.

At block 708, the pass band of IR light filtered by the tunable filter 126 may reach the image sensor 128 of the electronic device 100. At block 710, an IR image of the face or the iris may be formed by the image sensor 128.

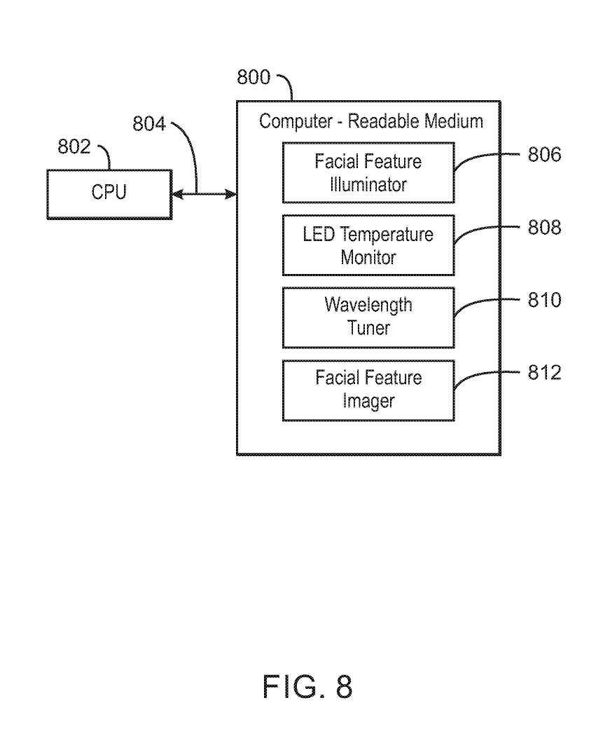

FIG. 8 is a block diagram showing a medium 800 that contains logic for compensating for thermal drift in an IR LED. The medium 800 may be a non-transitory computer-readable medium that stores code that can be accessed by a computer processing unit (CPU) 802 via a bus 804. For example, the computer-readable medium 800 can be a volatile or non-volatile data storage device. The medium 800 can also be a logic unit, such as an Application Specific Integrated Circuit (ASIC), a Field Programmable Gate Array (FPGA), or an arrangement of logic gates implemented in one or more integrated circuits, for example.

The medium 800 may include modules 806-812 configured to perform the techniques described herein. For example, a facial feature illuminator 806 may be configured to illuminate a user's facial features using a wavelength of IR light emitted by the IR LED 120. An IR LED temperature monitor 808 may be configured to monitor the temperature of the IR LED 120 using the temperature sensor 122. A wavelength tuner 810 is configured to tune the wavelength of the received IR light as the wavelength of the IR LED 120 drifts with temperature. A facial feature imager 812 may be configured to use the tuned IR light to obtain an image of the user's facial features. In some embodiments, the modules 806-812 may be modules of computer code configured to direct the operations of the processor 802.

The block diagram of FIG. 8 is not intended to indicate that the medium 800 is to include all of the components shown in FIG. 8. Further, the medium 800 may include any number of additional components not shown in FIG. 8, depending on the details of the specific implementation.

### EXAMPLES

Example 1 is an electronic device for compensating for temperature drift of a Light Emitting Diode (LED). The electronic device includes an LED assembly to illuminate a facial feature, the LED assembly comprising an LED and a temperature sensor to measure a temperature of the LED; a tunable filter to filter a wavelength of a pass band of light as the temperature of the LED changes as indicated by the temperature sensor; and an image sensor to receive the pass band of light filtered by the tunable filter.

Example 2 includes the electronic device of example 1, including or excluding optional features. In this example, the pass band of light is 5 to 20 nm wide.

Example 3 includes the electronic device of any one of examples 1 to 2, including or excluding optional features. In this example, a pass filter is disposed over the image sensor. Optionally, the pass filter is to sharpen the pass band of light. Optionally, the pass filter is to implement a stop band.

Example 4 includes the electronic device of any one of examples 1 to 3, including or excluding optional features. In this example, the electronic device includes a lens disposed over the pass filter, wherein the lens is to focus the pass band of light onto the pass filter. Optionally, the tunable filter is disposed over the lens.

Example 5 includes the electronic device of any one of examples 1 to 4, including or excluding optional features. In this example, the tunable filter comprises one or more liquid crystal (LC) layers.

Example 6 includes the electronic device of any one of examples 1 to 5, including or excluding optional features. In this example, the tunable filter comprises an electrochromic filter.

Example 7 includes the electronic device of any one of examples 1 to 6, including or excluding optional features. In this example, the tunable filter comprises an interferometer. Optionally, the interferometer comprises a Fabry-Perot interferometer. Optionally, the electronic device includes a lens disposed over the Fabry-Perot interferometer, wherein the lens is to widen a field of view.

Example 8 includes the electronic device of any one of examples 1 to 7, including or excluding optional features. In this example, the LED is an infrared LED.

Example 9 is a method for compensating for temperature drift of a Light Emitting Diode (LED). The method includes illuminating a facial feature using the LED; monitoring a temperature of the LED using a temperature sensor; filtering a wavelength of a pass band of light to obtain a filtered pass band of light as the temperature of the LED changes as indicated by the temperature sensor; receiving the filtered pass band of light by an image sensor; and forming an image of the facial feature.

Example 10 includes the method of example 9, including or excluding optional features. In this example, filtering a wavelength of a pass band of light comprises activating one or more liquid crystal (LC) layers. Optionally, activating one or more LC layers comprises selecting an LC material, crystal alignment, and crystal thickness to make the one or more LC layers reflective for the pass band of light. Optionally, activating one or more LC layers comprises selecting an excitation frequency and voltage to make the one or more LC layers reflective for the pass band of light.

Example 11 includes the method of any one of examples 9 to 10, including or excluding optional features. In this example, filtering a wavelength of a pass band of light comprises selecting a distance between mirrors of an interferometer.

Example 12 includes the method of any one of examples 9 to 11, including or excluding optional features. In this example, filtering a wavelength of a pass band of light comprises applying a charge to an electrochromic material that is absorptive for the wavelength of the pass band of light when the charge is applied to the electrochromic material.

Example 13 includes the method of any one of examples 9 to 12, including or excluding optional features. In this example, the method includes using a lens to focus the filtered pass band of light onto a pass filter.

Example 14 is at least one computer-readable medium. The computer-readable medium includes instructions that direct the processor to illuminate a facial feature using a Light Emitting Diode (LED); monitor a temperature of the LED using a temperature sensor; filter a wavelength of a pass band of light to obtain a filtered pass band of light as the temperature of the LED changes as indicated by the temperature sensor; and form an image of the facial feature at an image sensor.

Example 15 includes the computer-readable medium of example 14, including or excluding optional features. In this example, the computer-readable medium includes instructions to direct the processor to filter a wavelength of a pass band of light by activating one or more liquid crystal (LC) layers. Optionally, the computer-readable medium includes instructions to direct the processor to activate one or more LC layers by selecting the excitation frequency and voltage that make the one or more LC layers reflective for the pass band of light.

Example 16 includes the computer-readable medium of any one of examples 14 to 15, including or excluding optional features. In this example, the computer-readable medium includes instructions to direct the processor to filter a wavelength of a pass band of light by selecting a distance between at least two mirrors of an interferometer.

Example 17 includes the computer-readable medium of any one of examples 14 to 16, including or excluding optional features. In this example, the computer-readable medium includes instructions to direct the processor to filter a wavelength of a pass band of light by applying a charge to an electrochromic material.

Example 18 is an apparatus for compensating for temperature drift of a Light Emitting Diode (LED). The apparatus includes a means for illuminating a facial feature; a means for monitoring a temperature of the LED; a means for filtering a wavelength of a pass band of light to obtain a filtered pass band of light as the temperature of the LED changes as indicated by the means for monitoring the temperature of the LED; a means for receiving the filtered pass band of light; and a means for forming an image of the facial feature.

Example 19 includes the apparatus of example 18, including or excluding optional features. In this example, the means for illuminating a facial feature comprises an LED. Optionally, the means for illuminating a facial feature comprises an infrared LED.

Example 20 includes the apparatus of any one of examples 18 to 19, including or excluding optional features. In this example, the means for monitoring a temperature of the LED comprises a temperature sensor.

Example 21 includes the apparatus of any one of examples 18 to 20, including or excluding optional features. In this example, the means for filtering a wavelength of a pass band of light comprises activating one or more liquid crystal (LC) layers.

Example 22 includes the apparatus of any one of examples 18 to 21, including or excluding optional features. In this example, the means for filtering a wavelength of a pass band of light comprises varying a distance between at least two mirrors.

Example 23 includes the apparatus of any one of examples 18 to 22, including or excluding optional features. In this example, the means for filtering a wavelength of a pass band of light comprises applying a charge to an electrochromic material.

Example 24 includes the apparatus of any one of examples 18 to 23, including or excluding optional features. In this example, the means for receiving the filtered pass band of light comprises an image sensor. Optionally, the apparatus includes a means for focusing the filtered pass band of light onto the image sensor. Optionally, the means for focusing the filtered pass band of light is a lens.

Example 25 includes the apparatus of any one of examples 18 to 24, including or excluding optional features. In this example, the apparatus includes a means for sharpening the filtered pass band of light. Optionally, the means for sharpening the filtered pass band of light is a pass filter.

Example 26 is a mobile device capable of compensating for temperature drift of a Light Emitting Diode (LED) for imaging a facial feature. The device includes an LED assembly to illuminate a facial feature, the LED assembly comprising an LED and a temperature sensor to measure a temperature of the LED; a tunable filter to filter a wavelength of a pass band of light as the temperature of the LED changes as indicated by the temperature sensor; and an image sensor to receive the pass band of light filtered by the tunable filter.

Example 27 includes the device of example 26, including or excluding optional features. In this example, the pass band of light is 5 to 20 nm wide.

Example 28 includes the device of any one of examples 26 to 27, including or excluding optional features. In this example, a pass filter is disposed over the image sensor. Optionally, the pass filter is to sharpen the pass band of light. Optionally, the pass filter is to implement a stop band.

Example 29 includes the device of any one of examples 26 to 28, including or excluding optional features. In this example, the device includes a lens disposed over the pass filter, wherein the lens is to focus the pass band of light onto the pass filter. Optionally, the tunable filter is disposed over the lens.

Example 30 includes the device of any one of examples 26 to 29, including or excluding optional features. In this example, the tunable filter comprises one or more liquid crystal (LC) layers.

Example 31 includes the device of any one of examples 26 to 30, including or excluding optional features. In this example, the tunable filter comprises an electrochromic filter.

Example 32 includes the device of any one of examples 26 to 31, including or excluding optional features. In this example, the tunable filter comprises an interferometer. Optionally, the interferometer comprises a Fabry-Perot interferometer. Optionally, the device includes a lens disposed over the Fabry-Perot interferometer, wherein the lens is to widen a field of view.

Example 33 includes the device of any one of examples 26 to 32, including or excluding optional features. In this example, the LED is an infrared LED.

Some embodiments may be implemented in one or a combination of hardware, firmware, and software. Some embodiments may also be implemented as instructions stored on the tangible, non-transitory, machine-readable medium, which may be read and executed by a computing platform to perform the operations described. In addition, a machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the method or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An electronic device for compensating for temperature drift of a Light Emitting Diode (LED), comprising:
an LED assembly to illuminate a facial feature, the LED assembly comprising an LED and a temperature sensor to measure a temperature of the LED;
a tunable filter to filter a wavelength of a pass band of light as the temperature of the LED changes as indicated by the temperature sensor; and
an image sensor to receive the pass band of light filtered by the tunable filter.

2. The electronic device of claim 1, wherein the pass band of light is 5 to 20 nm wide.

3. The electronic device of claim 1, wherein a pass filter is disposed over the image sensor.

4. The electronic device of claim 3, wherein the pass filter is to sharpen the pass band of light.

5. The electronic device of claim 3, wherein the pass filter is to implement a stop band.

6. The electronic device of claim 1, comprising a lens disposed over the pass filter, wherein the lens is to focus the pass band of light onto the pass filter.

7. The electronic device of claim 6, wherein the tunable filter is disposed over the lens.

8. The electronic device of claim 1, wherein the tunable filter comprises one or more liquid crystal (LC) layers.

9. The electronic device of claim 1, wherein the tunable filter comprises an electrochromic filter.

10. The electronic device of claim 1, wherein the tunable filter comprises an interferometer.

11. The electronic device of claim 10, wherein the interferometer comprises a Fabry-Perot interferometer.

12. The electronic device of claim 11, comprising a lens disposed over the Fabry-Perot interferometer, wherein the lens is to widen a field of view.

13. The electronic device of claim 1, wherein the LED is an infrared LED.

14. A method for compensating for temperature drift of a Light Emitting Diode (LED), comprising:
illuminating a facial feature using the LED;
monitoring a temperature of the LED using a temperature sensor;
filtering a wavelength of a pass band of light to obtain a filtered pass band of light as the temperature of the LED changes as indicated by the temperature sensor;
receiving the filtered pass band of light by an image sensor; and
forming an image of the facial feature.

15. The method of claim 14, wherein filtering a wavelength of a pass band of light comprises activating one or more liquid crystal (LC) layers.

16. The method of claim 15, wherein activating one or more LC layers comprises selecting an LC material, crystal alignment, and crystal thickness to make the one or more LC layers reflective for the pass band of light.

17. The method of claim 15, wherein activating one or more LC layers comprises selecting an excitation frequency and voltage to make the one or more LC layers reflective for the pass band of light.

18. The method of claim 14, wherein filtering a wavelength of a pass band of light comprises selecting a distance between mirrors of an interferometer.

19. The method of claim 14, wherein filtering a wavelength of a pass band of light comprises applying a charge to an electrochromic material that is absorptive for the wavelength of the pass band of light when the charge is applied to the electrochromic material.

20. The method of claim 14, comprising using a lens to focus the filtered pass band of light onto a pass filter.

21. At least one computer-readable medium, comprising instructions to direct a processor to:
illuminate a facial feature using a Light Emitting Diode (LED);
monitor a temperature of the LED using a temperature sensor;
filter a wavelength of a pass band of light to obtain a filtered pass band of light as the temperature of the LED changes as indicated by the temperature sensor; and
form an image of the facial feature at an image sensor.

22. The at least one computer-readable medium of claim 21, comprising instructions to direct the processor to filter a wavelength of a pass band of light by activating one or more liquid crystal (LC) layers.

23. The at least one computer-readable medium of claim 22, comprising instructions to direct the processor to activate one or more LC layers by selecting the excitation frequency and voltage that make the one or more LC layers reflective for the pass band of light.

24. The at least one computer-readable medium of claim 21, comprising instructions to direct the processor to filter a wavelength of a pass band of light by selecting a distance between mirrors of an interferometer.

25. The at least one computer-readable medium of claim 21, comprising instructions to direct the processor to filter a wavelength of a pass band of light by applying a charge to an electrochromic material.
